(19) United States
(12) Patent Application Publication
(10) Pub. No.: US 2026/0248136 A1
(43) Pub. Date: Aug. 27, 2026

(54) Method for Preparing Hypochlorous Acid Solutions Having Different Concentrations, Hypochlorous Acid Solutions and Uses Thereof

(71) Applicants: CRAWFORD GLOBAL LIMITED, Hong Kong (CN); ETI SOLID STATE LIGHTING INC, Wheeling, IL (US); DERNIER AND HAMLYN INC., Wheeling, IL (US)

(72) Inventors: Donglei WANG, Zhuhai, Guangdong (CN); Qian LI, Zhuhai, Guangdong (CN); Li ZHANG, Zhuhai, Guangdong (CN); Songhong DING, Zhuhai, Guangdong (CN)

(21) Appl. No.: 18/725,770

(22) PCT Filed: Dec. 30, 2021
(86) PCT No.: PCT/CN2021/143415

§ 371 Date: Jun. 29, 2024

(51) Int. Cl. A01N 59/00; A01N 25/02; A01P 1/00; C01B 11/04

(52) U.S. Cl. CPC A01N 59/00; A01N 25/02; A01P 1/00; C01B 11/04

(57) ABSTRACT

Provided are a method for preparing hypochlorous acid solutions having different concentrations, hypochlorous acid solutions and uses thereof. The preparation method includes: an available chlorine concentration of a hypochlorous acid solution is positively correlated with the mass of salt, electrolysis time and electrolytic current, and is negatively correlated with the mass of water, and a hypochlorous acid generator is used to prepare a hypochlorous acid solution having a target concentration by means of diaphragm-free electrolysis of NaCl. By applying the technical solution of the present disclosure, a target available chlorine concentration can be substituted into a relational expression to obtain corresponding preparation parameters, and these preparation parameters are preset before electrolysis by the hypochlorous acid generator such that a desired hypochlorous acid aqueous solution is directly prepared via simple operation. The prepared hypochlorous acid solution exhibits a stable property and a strong sterilization effect.

### TECHNICAL FIELD

The present disclosure relates to the field of hypochlorous acid production, and specifically relates to a method for preparing hypochlorous acid solutions having different concentrations, hypochlorous acid solutions and uses thereof.

### BACKGROUND

Hypochlorous acid can kill pathogenic agents such as viruses, bacteria and human body idioblasts, but is free of damaging normal cells. It is a kind of safer and more effective disinfection product than 84 Disinfectant and 75% alcohol, etc. for our human body. Compared with traditional bactericides, hypochlorous acid has a strong oxidizing property and small molecular weight; moreover, it is electrically neutral and readily diffused onto bacterial surface and penetrates cytomembrane into bacterial cells such that bacterial proteins are oxidized to kill the bacteria. Moreover, various microorganisms can be killed at a low available chlorine concentration. Weakly acidic hypochlorous acid solution has lots of advantages such as broad spectrum and efficiency, safety and innocuousness, as well as eco-friendliness; it has been identified as a food-grade antibacterial agent in USA, China, and Japan. Moreover, the hypochlorous acid solution is a kind of novel and efficient disinfectant capable of acting on air, object surface and skin degerming simultaneously, and can be applied in lots of occasions with higher safety requirements for disinfection, and can achieve a good disinfection effect.

Most of the existing hypochlorous acid products on the market have only one fixed available chlorine concentration, i.e., high concentration or low concentration and thus, can be only applied in the specific scenes. In the process of preparing hypochlorous acid solutions by a traditional electrolytic route, high concentration of hypochlorous acid solution is generally prepared first, and then diluted according to requirements. The process of obtaining hypochlorous acid solution having a target available chlorine concentration is comparatively complex; high concentration of hypochlorous acid solution has an odor of chlorine gas and smells pungent, and there exists certain potential risk during its storage and transportation. Moreover, there probably exist problems, i.e., failure of achieving desired disinfection effect caused by inaccurate concentration after dilution, or low safety. Therefore, its application is limited to a large extent.

### SUMMARY

The major objective of the present disclosure is to provide a method for preparing hypochlorous acid solutions having different concentrations, hypochlorous acid solutions and uses thereof, so as to solve the problems in the art, i.e., complex process of preparing a hypochlorous acid solution having a target available chlorine concentration, single available chlorine concentration, and limited application caused thereby.

To achieve the above objective, according to one aspect of the present disclosure, provided are hypochlorous acid solutions having different concentrations; the method includes: an available chlorine concentration of the hypochlorous acid solution is positively correlated with mass of a salt, electrolysis time and electrolytic current, and is negatively correlated with mass of water; where the salt is NaCl having a mass denoted as M_{NaCl} with a unit of g; the mass of water is denoted as M_{water} with a unit of Kg; the electrolytic current I has a unit of A; the electrolysis time t has a unit of h; and the available chlorine concentration of the hypochlorous acid solution to be prepared is denoted as ACC_{available chlorine} with a unit of mg/L; a hypochlorous acid generator is used to prepare the hypochlorous acid solution having a target concentration by means of diaphragm-free electrolysis of the NaCl.

Furthermore, a relational expression among the available chlorine concentration ACC_{available chlorine}, the mass of NaCl M_{NaCl}, the mass of water M_{water}, the electrolysis time t and the electrolytic current I is as follows: ACC_{available chlorine}=(C+A×M_{NaCl}+B×M_{water})×(1.32304It)×1000 (1), wherein, A, B, and C denote coefficients of the relational expression.

Furthermore, in the relational expression, the coefficient A is 0.0474-0.0526; the coefficient B is −0.7878 to −0.7682; the coefficient C is 0.9342-0.9498; preferably, the coefficient A is 0.0500; the coefficient B is −0.7780, and the coefficient C is 0.9420.

Furthermore, a process for determining four variables, the mass of NaCl M_{NaCl}, the mass of water M_{water}, the electrolysis time t and the electrolytic current I includes: setting three variables, the mass of NaCl M_{NaCl}, the mass of water M_{water}, and the electrolytic current I constant, adjusting the electrolysis time t according to the relational expression, and obtaining an available chlorine concentration ACC_{available chlorine} of a desired hypochlorous acid solution.

Furthermore, the mass of NaCl M_{NaCl} is 1-10 g, and preferably 1-4 g; the mass of water M_{water} is 0.2-1 kg, and preferably 0.5-1 kg.

Furthermore, in the electrolytic process, a pH regulator is used for regulating a pH value of an electrolyte solution; preferably, the pH regulator is an aqueous solution of acetic acid; preferably, the electrolyte solution has a pH value of 5.0-6.5, and more preferably, 5.5-6.0.

Furthermore, in the electrolytic process, current is 1.0-2.0 A, and preferably 1.8 A.

Furthermore, the relational expression is obtained by the following operations: establishing a linear regression equation model among the available chlorine concentration ACC_{available chlorine}, the mass of NaCl M_{NaCl}, the mass of water M_{water}, the electrolysis time t and the electrolytic current I; substituting acquired historical data into the model by SPSS software to obtain three coefficients A, B, and C, and thus a relational expression among the available chlorine concentration ACC_{available chlorine}, the mass of NaCl M_{NaCl}, the mass of water M_{water}, the electrolysis time t and the electrolytic current I:

$${ACC}_{available chlorine} = ( C + A \times {M}_{NaCl} + B \times {M}_{water} ) \times ( 1.32304 I t ) \times 1000 .$$

According to another aspect of the present disclosure, further provided is a hypochlorous acid solution prepared by the preparation method of the present disclosure; preferably, the available chlorine concentration ACC_{available chlorine} of the hypochlorous acid solution is 5-200 mg/L.

According to a further aspect of the present disclosure, further provided is use of a hypochlorous acid solution prepared by the preparation method of the present disclosure, including: the hypochlorous acid solution has an available chlorine concentration of 5-60 mg/L, and is for use in disinfection of food washing, kitchen surfaces, and drinking water pipelines; alternatively, the hypochlorous acid solution has an available chlorine concentration of 60-150 mg/L, and is for use in disinfection of medical instruments, medical facilities, and air in school; alternatively, and the hypochlorous acid solution has an available chlorine concentration of 150-200 mg/L, and is for use in disinfection of washrooms and livestock farms.

By applying the technical solution of the present disclosure, before the preparation, an available chlorine concentration of the target hypochlorous acid solution is substituted into the relational expression to obtain corresponding I, t, M_{NaCl}, and M_{water}; these parameters are preset before electrolysis by a hypochlorous acid generator, thus directly preparing a hypochlorous acid aqueous solution having a desired available chlorine concentration. In the present disclosure, different parameters are preset by a reliable relational expression such that hypochlorous acid solutions having different available chlorine concentrations can be prepared conveniently; there is a wide range of concentrations, and hypochlorous acid solutions corresponding to any available chlorine concentration within the range of 5-200 mg/L can be generated. Moreover, relevant parameters are preset; therefore, there is no need for process monitoring in the present disclosure, and it is easy to operate, capable of greatly saving materials and labor costs. Additionally, a pH regulator is further added to the electrolytic process of the present disclosure such that electrolysis is more stable; moreover, hypochlorous acid in the obtained hypochlorous acid solution can be present stably and thus has a better bactericidal effect comparatively.

On the other hand, the direct preparation of hypochlorous acid solutions having different concentrations provides a convenient solution for disinfection and sterilization under different application scenarios. Moreover, the present disclosure further provides application schemes directed to different application scenarios such as skin degerming, disinfection of fruits and vegetables, and site disinfection, which is convenient for directing the use of hypochlorous acid solutions having different concentrations.

### DETAILED DESCRIPTION OF THE EMBODIMENTS

It needs to be indicated that examples in the present application may be in combination with features in the examples in the absence of conflict. The present disclosure will be described in detail with reference to the examples below.

### Term Interpretation:

Hypochlorous acid solution in the present disclosure refers to an aqueous solution of hypochlorous acid.

Concentration of hypochlorous acid solution refers to an available chlorine concentration. Available chlorine refers to chlorine existing in an oxidation state in a solution, for example, hypochlorous acid, hypochlorite, chlorate radical, chlorine gas molecule, etc. These forms of chlorine all have the function of oxidizing sterilizing and disinfecting. Available chlorine concentration refers to milligrams of available chlorine contained in each liter of hypochlorous acid solution.

As described in the Background of the present disclosure, there are problems in the art, i.e., complex process of preparing a hypochlorous acid solution having a target available chlorine concentration, single available chlorine concentration, and limited application caused thereby. Directed to the above problems, in a typical embodiment of the present disclosure, provided are hypochlorous acid solutions having different concentrations; the method includes: an available chlorine concentration of the hypochlorous acid solution is positively correlated with mass of a salt, electrolysis time and electrolytic current, and is negatively correlated with mass of water; where the salt is NaCl having a mass denoted as M_{NaCl} with a unit of g; the mass of water is denoted as M_{water} with a unit of kg; the electrolytic current I has a unit of A; the electrolysis time t has a unit of h; the available chlorine concentration of the hypochlorous acid solution to be prepared is denoted as ACC_{available chlorine} with a unit of mg/L; a hypochlorous acid generator is used to prepare the hypochlorous acid solution having a target concentration by means of diaphragm-free electrolysis of the NaCl.

Hypochlorous acid solutions having different available chlorine concentrations need be used in different application scenarios in consideration of disinfection effects and safety. Conventional methods are to prepare high concentration of hypochlorous acid solution first, and then to dilute it into different concentrations. In contrast, the present disclosure gives sufficient consideration to each parameter affecting the available chlorine concentration and electrolytic process, including theoretical available chlorine concentration, electrolytic efficiency, total electricity in the electrolytic process, electron transfer number of products. A relational expression among the available chlorine concentration ACC_{available chlorine} of hypochlorous acid solution, the mass of NaCl M_{NaCl} during preparation of hypochlorous acid solution via electrolysis, the mass of water M_{water}, the electrolysis time t and the electrolytic current I is obtained first; when a hypochlorous acid solution having a target available chlorine concentration is prepared, the relational expression is utilized to obtain the corresponding I, t, M_{NaCl}, and M_{water}; moreover, these parameters are preset before the electrolysis by a hypochlorous acid generator, thereby directly preparing a hypochlorous acid aqueous solution having a desired available chlorine concentration.

Compared with the conventional methods of preparation first and then dilution, relevant parameters are preset in the present disclosure; therefore, there is no need for process monitoring, and it is easy to operate, capable of greatly saving materials and labor costs. Based on the disinfection requirements of different scenarios, a target quantity of hypochlorous acid solution having a target available chlorine concentration can be prepared on site and also can be prepared upon being in need of use. Such a configuration avoids the problems such as decreased disinfection effect caused by the change of pH during the storage of hypochlorous acid solution, and potential safety hazards caused by the escape of chlorine gas.

To further increase the reliability of the relational expression, thus making it possessing practical guiding significance more, in a preferred embodiment, there is a relational expression among the available chlorine concentration ACC_{available chlorine}, the mass of NaCl M_{NaCl}, the mass of water M_{water}, the electrolysis time t and the electrolytic current I: ACC_{available chlorine}=(C+A×M_{NaCl}+B×M_{water})× (1.32304It)×1000 (1), where, A, B, and C denote coefficients of the relational expression.

In a preferred embodiment, in the above relational expression, the coefficient A is 0.0474-0.0526; the coefficient B is −0.7878 to −0.7682; the coefficient C is 0.9342-0.9498; preferably, the coefficient A is 0.0500; the coefficient B is −0.7780, and the coefficient C is 0.9420, thus obtaining the corresponding relational expression.

In an example, the preparation method of the present disclosure specifically includes the following steps:
step S1, a relational expression among the available chlorine concentration ACC_{available chlorine} of hypochlorous acid solution, the mass of NaCl M_{NaCl} during preparation of hypochlorous acid solution via electrolysis, the mass of water M_{water}, the electrolysis time t and the electrolytic current I is provided as follows: ACC_{available chlorine}=(C+A×M_{NaCl}+B×M_{water})×(1.32304It)×1000, the coefficient A is 0.0474 to 0.0526; the coefficient B is −0.7878 to −0.7682; the coefficient C is 0.9342 to 0.9498; preferably, ACC_{available chlorine}=(0.9420+0.0500×M_{NaCl}−0.7780×M_{water})×(1.32304It)×1000;
step S2, electrolytic raw materials NaCl, a pH regulator and water are prepared; four variables, the mass of NaCl M_{NaCl}, the mass of water M_{water}, the electrolysis time t and the electrolytic current I are determined according to the available chlorine concentration ACC_{available chlorine} of the hypochlorous acid solution to be prepared and the relational expression, and then the electrolytic raw materials are mixed to form an electrolyte solution and placed into a hypochlorous acid generator for electrolysis, to obtain the hypochlorous acid solution having the corresponding available chlorine concentration ACC_{available chlorine}.

It needs to be indicated that the specific source of the above relational expression in the present disclosure is merely provided during the establishment of the above relational expression; in practical use, a hypochlorous acid solution having a target concentration is prepared according to the present disclosure available. The specific establishment process of the above relational expression is not a key point to the present disclosure and thus, is free of affecting the integrity of the method for preparing a hypochlorous acid solution having a target concentration.

To further simply the operation procedure, in a preferred embodiment, a process for determining four variables, i.e., the mass of NaCl M_{NaCl}, the mass of water M_{water}, the electrolysis time t and the electrolytic current I includes: setting three variables, the mass of NaCl M_{NaCl}, the mass of water M_{water}, and the electrolytic current I constant, adjusting the electrolysis time t according to the relational expression, and obtaining an available chlorine concentration ACC_{available chlorine} of a desired hypochlorous acid solution. Electrolysis time is easier to be changed and monitored in practical operation relative to other three variables. Therefore, values of the three variables are determined in advance, and finally electrolysis time is adjusted adaptively, which is more operable. Certainly, if reaction needs to be ended within a certain period of time, the remaining one variable is changed and time and other two variables are set constant, which may also achieve the similar effect; here is no more detailed description.

In a preferred embodiment, the mass of NaCl M_{NaCl} is 1-10 g, and preferably 1-4 g; the mass of water M_{water} is 0.2-1 kg, and preferably 0.5-1 kg. M_{NaCl} and M_{water} are defined within the above range, which may maintain a proper concentration of chloride ions, beneficial to reducing resistance of the electrolyte solution, thus improving electrolytic efficiency and increasing the yield of hypochlorous acid during the electrolytic process. In this way, sufficient amount of Cl⁻ may be provided nearby an anode for reaction, and accumulation of excessive Cl⁻ is further avoided such that the available chlorine concentration in the hypochlorous acid solution of a product is controlled within the target range. Moreover, M_{NaCl} and M_{water} are defined within the above range, which is further beneficial to further improving the reliability of the relational expression such that the available chlorine concentration obtained via practical electrolysis is closer to the value proposed before electrolysis.

To further improve the electrolytic efficiency, in a preferred embodiment, a pH regulator is used to regulate a pH value of an electrolyte solution during electrolysis; preferably, the pH regulator is an aqueous solution of acetic acid; in practical use, an aqueous solution of acetic acid having an acidity of 5% is generally used such that the aqueous solution of acetic acid in the electrolyte solution has a volume fraction of 3-5%. A pH value may be regulated by aqueous solution of acetic acid stably. Acetate radicals further have a certain buffering effect. Aqueous solution of acetic acid, as a pH regulator, may maintain the sub-acidity of the electrolyte solution such that the electrolytic process and the generated hypochlorous acid are more stable, and the relational expression is more reliable.

Preferably, the electrolyte solution has a pH value of 5.0-6.5, and more preferably, 5.5-6.0. Oxidation-state chlorine in a solution exists in different forms at different pH environment; it mainly exists in a form of Cl₂ under strong acid conditions, mainly exists in a form of HClO under weakly acidic conditions, and mainly exists in a form of CIO under alkaline conditions. Under the above pH conditions, the concentration of HClO in a product solution may be up to 90% above; the oxidizing bactericidal ability of HClO is 80 times that of CIO at an equal concentration. High concentration of HClO greatly improves the disinfection capacity of hypochlorous acid solution, which reduces the amount of a disinfectant used, and is also free of corrosion of an electrolytic cell and electrodes caused by too strong acidity.

To make the electrolytic process more stable and enhance the reliability of the relational expression, in a preferred embodiment, current in the electrolytic process is 1.0-2.0 A. When current is too high, the increase of available chlorine is slow, and current efficiency decreases. Current is further preferably 1.8 A after taking overall consideration to the factors such as available chlorine concentration in the product solution, voltage and current efficiency.

In a preferred embodiment, the relational expression is obtained by the following operations: establishing a linear regression equation model among the available chlorine concentration ACC_{available} chlorine, the mass of NaCl M_{NaCl}, the mass of water M_{water}, the electrolysis time t and the electrolytic current I; substituting acquired historical measured data into the model by SPSS software to obtain three coefficients A, B, and C, and thus a relational expression among the available chlorine concentration ACC_{available chlorine}, the mass of NaCl M_{NaCl}, the mass of water M_{water}, the electrolysis time t and the electrolytic current I: ACC_{available chlorine}=(C+A×M_{NaCl}+B×M_{water})×(1.32304It)×1000.

The historical measured data is obtained by the following steps: NaCl, water and pH regulator are mixed and respectively prepared into multiple groups of standard sample solutions; each group of sample solution is electrolyzed to prepare hypochlorous acid standard solutions having different concentrations; the mass of the used NaCl M_{NaCl}, the mass of water M_{water}, the electrolysis time t, the electrolytic current I, and the measured available chlorine concentration are recorded.

In a further typical embodiment of the present disclosure, provided is a hypochlorous acid solution prepared by the preparation method of the present disclosure; preferably, the available chlorine concentration ACC_{available chlorine} of the hypochlorous acid solution is 5-200 mg/L. The corresponding I, t, M_{NaCl}, and V_{water} obtained via the relational expression of the hypochlorous acid aqueous solution are preset in the hypochlorous acid generator, which may directly prepare hypochlorous acid aqueous solutions having different available chlorine concentrations for a short period of time via simple operation. Moreover, hypochlorous acid with strong oxidizing bactericidal ability in the product has a high concentration.

In a preferred embodiment, use of the hypochlorous acid solution is defined. The hypochlorous acid solution has an available chlorine concentration of 5-60 mg/L, and is for use in disinfection of food washing, kitchen surfaces, and drinking water pipelines; alternatively, the hypochlorous acid solution has an available chlorine concentration of 60-150 mg/L, and is for use in disinfection of medical instruments, medical facilities, and air in school; alternatively, and the hypochlorous acid solution has an available chlorine concentration of 150-200 mg/L, and is for use in the disinfection of washrooms and livestock farms. 60 mg/L of low available chlorine concentration below is a food contactable range certificated by Food and Drug Administration (FDA); the hypochlorous acid solution having an available chlorine concentration of 60-150 mg/L has a sterilizing rate of greater than 99.9% to Staphylococcus aureus, Escherichia coli, etc. within 5-10 min; the hypochlorous acid solution having an available chlorine concentration of 200 mg/L may achieve a sterilizing rate of greater than 99.9% within 1 min. Weakly acidic hypochlorous acid solution hardly releases chlorine and thus, is free of irritating eyeballs and mucosa, thus reducing damage to users. The hypochlorous acid solutions having different concentrations one-step prepared in the present disclosure may be applied to different scenarios according to the needs, which is of more general applicability.

The present application will be further described in detail with reference to detailed examples below. These examples may not be construed as limiting the scope set forth in the present application.

### Examples 1-12

A linear regression equation model among the available chlorine concentration ACC_{available chlorine}, the mass of NaCl M_{NaCl}, the mass of water M_{water}, the electrolysis time t and the electrolytic current I was established; acquired historical data (as shown in Table 1) was substituted into the model by SPSS software to calculate coefficient A of 0.0500, coefficient B of −0.7780, and coefficient C of 0.9420, to obtain the following relational expression:

$${ACC}_{available chlorine} = ( 0.9420 + 0.0500 \times {M}_{NaCl} - 0.778 \times {M}_{water} ) \times ( 1.32304 I t ) \times 1 \; 000 \qquad ( 1 )$$

TABLE 1

| | M_{NaCl} | M_{water} | Electrolysis | Measured available |
|---|---|---|---|---|
| | g | Kg | time min | chlorine mg/L |
| Historical data 1 | 4 | 1 | 13 | 192 |
| Historical data 2 | 4 | 1 | 12 | 172 |
| Historical data 3 | 4 | 1 | 11 | 158 |
| Historical data 4 | 2 | 1 | 9 | 96 |
| Historical data 5 | 2 | 1 | 8.5 | 88 |
| Historical data 6 | 2 | 1 | 8 | 84 |
| Historical data 7 | 2 | 0.5 | 10 | 264 |
| Historical data 8 | 2 | 0.5 | 8 | 209 |
| Historical data 9 | 2 | 0.5 | 7 | 177 |
| Historical data 10 | 1 | 1 | 4 | 35 |

A salt, a pH regulator and water were prepared; the salt was NaCl with an analytically pure grade; the pH regulator was distilled vinegar having an acidity of 5%; pH of the mixed solution was maintained 5.5; cathode and anode of the hypochlorous acid generator were Ti-based ruthenium-iridium coated electrodes; constant current was 1.8 A, and electrolysis power was 16 w. The mass M_{NaCl} of the added NaCl in the electrolyte solution, the mass M_{water} of the added water in the electrolyte solution, and electrolysis time t were adjusted such that these parameters complied with the relational expression (1); these parameters were preset in the hypochlorous acid generator; salt, pH regulator and water were mixed to form the electrolyte solution, and then the electrolyte solution was placed into the hypochlorous acid generator for electrolysis, to obtain the hypochlorous acid solution. The actual available chlorine concentration of the hypochlorous acid solution prepared by an available chlorine tester was determined.

### Example 13

Example 13 merely differs from Example 1 in that the electrolyte solution has a pH value of 4.

### Example 14

Example 14 merely differs from Example 1 in that the electrolyte solution has a pH value of 5.

### Example 15

Example 15 merely differs from Example 1 in that the electrolyte solution has a pH value of 6.

### Example 16

Example 16 merely differs from Example 1 in that the electrolyte solution has a pH value of 6.5. Results of each example are shown in Table 2.

TABLE 2

| | Target | | | | Measured | |
|---|---|---|---|---|---|---|
| | available | | | | available | |
| | chlorine | M_{NaCl} | M_{water} | Electrolysis | chlorine | Relative |
| | mg/L | g | kg | time min | mg/L | deviation |
| Example 1 | 200 | 4 | 1 | 13.8 | 199 | 0.5% |
| Example 2 | 150 | 4 | 1 | 10.4 | 149 | 0.7% |
| Example 3 | 60 | 4 | 1 | 4.2 | 62 | 3.3% |
| Example 4 | 5 | 4 | 1 | 0.3 | 6 | 20.0% |
| Example 5 | 200 | 4 | 0.5 | 6.7 | 203 | 1.5% |
| Example 6 | 200 | 4 | 0.2 | 5.1 | 190 | 5.0% |
| Example 7 | 200 | 10 | 1 | 7.6 | 208 | 4.0% |
| Example 8 | 200 | 2 | 0.5 | 7.7 | 197 | 1.5% |
| Example 9 | 200 | 1 | 0.2 | 6.0 | 193 | 3.5% |
| Example 10 | 100 | 4 | 1 | 6.9 | 99 | 1.0% |
| Example 11 | 100 | 3 | 1 | 8.0 | 102 | 2.0% |
| Example 12 | 100 | 3 | 0.5 | 3.6 | 98 | 2.0% |
| Example 13 | 200 | 4 | 1 | 13.8 | 186 | 7.0% |
| Example 14 | 200 | 4 | 1 | 13.8 | 195 | 2.5% |
| Example 15 | 200 | 4 | 1 | 13.8 | 201 | 0.5% |
| Example 16 | 200 | 4 | 1 | 13.8 | 198 | 1.0% |

Relative deviation = | measured available chlorine − target available chlorine | ÷ target available chlorine × 100%

As can be seen from Table 2, the available chlorine concentration ACC_{available chlorine} of the hypochlorous acid solution to be prepared was substituted into the relational expression (1); hypochlorous acid solutions having different available chlorine concentrations may be prepared under different conditions of M_{NaCl}, M_{water}, and t. Moreover, the target available chlorine concentration substituted into the relational expression is basically consistent with the available chlorine concentration measured in practice, and there exists a small relative deviation, which proves the reliability of the relational expression in the present disclosure.

As can be seen from Table 2, when the pH value of the electrolyte solution is 4.0, the relative deviation is a little high; when the pH value of the electrolyte solution increases appropriately, the measured available chlorine concentration is closer to the target available chlorine. However, if the pH value of the electrolyte solution increases continuously to 6.5, the relative deviation between the measured available chlorine concentration and the target available chlorine concentration fails to decrease obviously. To sum up, 5.5-6.0 is selected as the optimal pH value of the electrolyte solution in the present disclosure.

1. A method for preparing hypochlorous acid solutions having different concentrations, wherein an available chlorine concentration of the hypochlorous acid solution is positively correlated with mass of a salt, electrolysis time and electrolytic current, and is negatively correlated with mass of water;
wherein the salt is NaCl having a mass denoted as M_{NaCl} with a unit of g; the mass of water is denoted as M_{water} with a unit of kg; the electrolytic current I has a unit of A; the electrolysis time t has a unit of h; and the available chlorine concentration of the hypochlorous acid solution to be prepared is denoted as ACC_{available chlorine} with a unit of mg/L;
a hypochlorous acid generator is used to prepare the hypochlorous acid solution having a target concentration by means of diaphragm-free electrolysis of the NaCl.

2. The preparation method according to claim 1, wherein a relational expression among the available chlorine concentration ACC_{available chlorine}, the mass of NaCl M_{NaCl}, the mass of water M_{water}, the electrolysis time t and the electrolytic current I is as follows:
$${ACC}_{available chlorine} = ( C + A \times {M}_{NaCl} + B \times {M}_{water} ) \times ( 1.32304 I t ) \times 1000 , \qquad ( 1 )$$
wherein, A, B, and C denote coefficients of the relational expression.

3. The preparation method according to claim 2, wherein in the relational expression, the coefficient A is 0.0474-0.0526; the coefficient B is −0.7878 to −0.7682; the coefficient C is 0.9342-0.9498; preferably, the coefficient A is 0.0500; the coefficient B is 0.7780; and the coefficient C is 0.9420.

4. The preparation method according to claim 2, wherein a process for determining four variables, the mass of NaCl M_{NaCl}, the mass of water M_{water}, the electrolysis time t and the electrolytic current I comprises: setting three variables, the mass of NaCl M_{NaCl}, the mass of water M_{water}, and the electrolytic current I constant, adjusting the electrolysis time t according to the relational expression, and obtaining an available chlorine concentration ACC_{available chlorine} of a desired hypochlorous acid solution.

5. The preparation method according to claim 1, wherein the mass of NaCl M_{NaCl} is 1-10 g; the mass of water M_{water} is 0.2-1 kg.

6. The preparation method according to 1, wherein in the electrolytic process, a pH regulator is used for regulating a pH value of an electrolyte solution.

7. The preparation method according to claim 1, wherein in the electrolytic process, current is 1.0-2.0 A.

8. The preparation method according to claim 2, wherein the relational expression is obtained by the following operations:
establishing a linear regression equation model among the available chlorine concentration ACC_{available chlorine}, the mass of NaCl M_{NaCl}, the mass of water M_{water}, the electrolysis time t and the electrolytic current I; substituting acquired historical measured data into the model by SPSS software to obtain three coefficients A, B, and C, and thus obtaining a relational expression among the available chlorine concentration ACC_{available chlorine}, the mass of NaCl M_{NaCl}, the mass of water M_{water}, the electrolysis time t and the electrolytic current I: ACC_{available} chlorine=(C+A×M_{NaCl}+B×M_{water})×(1.32304It)×1000.

9. A hypochlorous acid solution, prepared by the preparation method according to claim 1.

10. Use of the hypochlorous acid solution according to claim 9, wherein
the hypochlorous acid solution has an available chlorine concentration of 5-60 mg/L, and is for use in disinfection of food washing, kitchen surfaces, and drinking water pipelines; alternatively,
the hypochlorous acid solution has an available chlorine concentration of 60-150 mg/L, and is for use in disinfection of medical instruments, medical facilities, and air in school; alternatively, and
the hypochlorous acid solution has an available chlorine concentration of 150-200 mg/L, and is for use in disinfection of washrooms and livestock farms.

11. The preparation method according to claim 2, wherein the coefficient A is 0.0500; the coefficient B is −0.7780, and the coefficient C is 0.9420.

12. The preparation method according to claim 1, wherein the mass of NaCl M_{NaCl} is 1-4 g.

13. The preparation method according to claim 1, wherein the mass of water M_{water} is 0.5-1 kg.

14. The preparation method according to claim 6, wherein in the electrolytic process, the pH regulator is an aqueous solution of acetic acid.

15. The preparation method according to claim 6, wherein in the electrolytic process, the electrolyte solution has a pH value of 5.0-6.5.

16. The preparation method according to claim 6, wherein in the electrolytic process, the electrolyte solution has a pH value of 5.5-6.0.

17. The preparation method according to claim 1, wherein in the electrolytic process, current is 1.8 A.

18. The hypochlorous acid solution according to claim 9, wherein the hypochlorous acid solution having an available chlorine concentration ACC_{available chlorine} of 5-200 mg/L.

19. The preparation method according to claim 3, wherein a process for determining four variables, the mass of NaCl M_{NaCl}, the mass of water M_{water}, the electrolysis time t and the electrolytic current I comprises: setting three variables, the mass of NaCl M_{NaCl}, the mass of water M_{water}, and the electrolytic current I constant, adjusting the electrolysis time t according to the relational expression, and obtaining an available chlorine concentration ACC_{available chlorine} of a desired hypochlorous acid solution.

20. The preparation method according to claim 2, wherein the mass of NaCl M_{NaCl} is 1-10 g; the mass of water M_{water} is 0.2-1 kg.
